(19) United States
(12) Patent Application Publication
(10) Pub. No.: US 2023/0195347 A1
(43) Pub. Date: Jun. 22, 2023

(54) Thin-Provisioned File Copying Method, Apparatus and Device, and Readable Storage Medium

(71) Applicant: INSPUR SUZHOU INTELLIGENT TECHNOLOGY CO., LTD., Jiangsu (CN)

(72) Inventors: Hongwei LI, Jiangsu (CN); Dong ZHANG, Jiangsu (CN)

(21) Appl. No.: 18/005,003

(22) PCT Filed: Feb. 19, 2021
(86) PCT No.: PCT/CN2021/076953

§ 371 Date: Jan. 10, 2023

(30) Foreign Application Priority Data
Jul. 17, 2020 (CN) 202010692366.5

(51) Int. Cl. G06F 3/06

(52) U.S. Cl. CPC G06F 3/0643; G06F 3/0674; G06F 3/065; G06F 3/0664

(57) ABSTRACT

Provided are a thin-provisioned file copying method, apparatus and device, and a readable storage medium. The method includes: a destination host sends a copying request for a target file to a source host, and receives file information of the target file returned by the source host; if the target file is a thin-provisioned file, creating, according to the file information, a virtual storage area that has the same size as the target file and does not occupy disk space; and sending an acquisition request for a target data segment to the source host one by one, receiving the target data segment returned by the source host, and storing, in a thin-provisioned manner, the target data segment to a disk address corresponding to the virtual storage area, so as to copy the target file from the source host to the destination host.

### CROSS-REFERENCE TO RELATED APPLICATION

The present disclosure claims the priority based on Chinese Patent Application No. 202010692366.5, filed with the Chinese Patent Office on Jul. 17, 2020 and entitled “thin-provisioned file copying method, apparatus and device, and readable storage medium”, which is incorporated herein by reference in its entirety.

### TECHNICAL FIELD

The present disclosure relates to the field of computer technology, and in particular, to a thin-provisioned file copying method, apparatus and device, and a readable storage medium.

### BACKGROUND

The basic principle of thin provision is “allocation on write”, that is, space viewed by an upper-layer application and a user is only virtual storage space, the virtual storage space does not occupy physical disk space, and allocation of the physical disk space is performed only when data is written. Therefore, the thin provision technology can improve the utilization rate and flexibility of a physical storage device, and can provide larger storage space at a lower cost, realizing an “over allocation” function in storage.

However, the thin provision is configured for hosts and files. For example, host A is configured with thin provision, but host B is not configured with thin provision, and then after a file stored in host A in a thin-provisioned manner is copied to host B, the file will be stored in host B in a normal manner, that is, after the file originally stored in the thin-provisioned manner is copied across the hosts, the file becomes a thick-provisioned file, so that the file loses the advantages of thin provision in host B.

Therefore, after a thin-provisioned file is copied across hosts, how to retain the advantages of the thin-provisioned file is a problem that needs to be solved by a person skilled in the art.

### SUMMARY

In view of this, the purpose of the present disclosure is to provide a thin-provisioned file copying method, apparatus and device, and a readable storage medium, so as to retain the advantages of a thin-provisioned file after the thin-provisioned file is copied across hosts. The solution is as follows:

in a first aspect, the present disclosure provides a thin-provisioned file copying method, which is applied to a destination host, and includes:

sending a copying request for a target file to a source host, and receiving file information of the target file returned by the source host;

when the target file is a thin-provisioned file, creating, according to the file information, a virtual storage area that has the same size as the target file and does not occupy disk space;

sending, according to the file information, an acquisition request for a target data segment to the source host one by one, receiving the target data segment returned by the source host, and storing, in a thin-provisioned manner, the target data segment to a disk address corresponding to the virtual storage area, so as to copy the target file from the source host to the destination host, the target data segment being any one of all data segments included in the target file.

In an embodiment, before sending a copy request for a target file to a source host, the source host parses the metadata of the target file according to the type of a file system deployed by the source host to obtain a disk location where each data segment included in the target file is stored, and sends a copying notification message for the target file to the destination host.

In an embodiment, before the source host returns the file information, when the target file is a thin-provisioned file, the source host parses metadata of the target file according to the type of a file system deployed by the source host, so as to obtain a disk location where each data segment included in the target file is stored.

In an embodiment, before sending a copy request for a target file to a source host, the source host parses metadata of the target file according to the type of a file system deployed by the source host, so as to obtain a disk location where each data segment included in the target file is stored, and waits for the copying request.

In an embodiment, after copying the target file from the source host to the target host, the method further includes:

combining all data segments of the target file stored in the destination host into a destination file, and determining whether the destination file is consistent with the target file;

when the destination file is consistent with the target file, sending to the source host a notification message indicating that the target file is successfully copied;

when the destination file is inconsistent with the target file, sending to the source host a notification message indicating that the target file is failed to be copied.

In an embodiment, determining whether the target file is consistent with the target file includes:

calculating a destination MD5 value of the destination file, acquiring a source MD5 value of the target file from the file information, and determining whether the destination MD5 value is consistent with the source MD5 value.

In an embodiment, the types of file systems deployed by the source host and the destination host are different.

In a second aspect, the present disclosure provides a thin-provisioned file copying apparatus, which is applied to a destination host, and includes:

a sending module, configured to send a copying request for a target file to a source host, and receive file information of the target file returned by the source host;

a creation module, configured to create, according to the file information, a virtual storage area that has the same size as the target file and does not occupy disk space if the target file is a thin-provisioned file; and

a copying module, configured to send, according to the file information, an acquisition request for a target data segment to the source host one by one, receive the target data segment returned by the source host, and store, in a thin-provisioned manner, the target data segment to a disk address corresponding to the virtual storage area, so as to copy the target file from the source host to the destination host, the target data segment being any one of all data segments included in the target file.

In a third aspect, the present disclosure provides a thin-provisioned file copying device, includes:

a memory, configured to store a computer program; and

a processor, configured to execute the computer program to implement the thin-provisioned file copying method disclosed above.

In a fourth aspect, the present disclosure provides a readable storage medium, configured to store a computer program, wherein the computer program, when being executed by a processor, implements the thin-provisioned file copying method disclosed above.

It can be determined from the described solution that the present disclosure provides a thin-provisioned file copying method, which is applied to a destination host and includes: sending a copying request for a target file to a source host, and receiving file information of the target file returned by the source host; if the target file is a thin-provisioned file, creating, according to the file information, a virtual storage area that has the same size as the target file and does not occupy disk space; and sending, according to the file information, an acquisition request for a target data segment to the source host one by one, receiving the target data segment returned by the source host, and storing, in a thin-provisioned manner, the target data segment to a disk address corresponding to the virtual storage area, so as to copy the target file from the source host to the destination host, the target data segment being any one of all data segments included in the target file.

Hence, in the process of copying the thin-provisioned file from the source host to the destination host in the present disclosure, the destination host will create a virtual storage area that has the same size as the thin-provisioned file and does not occupy disk space, so as to prepare for storage of subsequent data. When the data included in the thin-provisioned file really needs to be written, a corresponding disk address is allocated for the data to be stored on the disk, so that after the thin-provisioned file is copied from the source host to the destination host, the thin-provisioned file is still a thin-provisioned file in the destination host. Therefore, after the thin-provisioned file is copied across the hosts, the advantages of thin provision is retained, and physical storage space of the destination host is also saved. In addition, in the present disclosure, only valid data in the target file (i.e. all data segments included in the target file) is transferred to the destination host, and the amount of data in the file to be transferred can also be reduced, thereby improving the transfer speed of the file, and improving the copying efficiency.

Accordingly, the thin-provisioned file copying apparatus and device, and the readable storage medium provided in the present disclosure also have the described technical effects.

### BRIEF DESCRIPTION OF THE DRAWINGS

To describe the technical solutions in the embodiments of the present disclosure or in the prior art more clearly, the following briefly introduces the accompanying drawings required for describing the embodiments or the prior art. Apparently, the accompanying drawings in the following description merely show embodiments of the present disclosure, and a person skilled in the art may still derive other drawings from the accompanying drawings without inventive efforts.

FIG. 1 is a flow chart of a thin-provisioned file copying method according to the present disclosure;

FIG. 2 is a flow chart of another thin-provisioned file copying method according to the present disclosure;

FIG. 3 is a schematic diagram of a thin-provisioned file copying apparatus according to the present disclosure; and

FIG. 4 is a schematic diagram of a thin-provisioned file copying device according to the present disclosure.

### DETAILED DESCRIPTION OF THE EMBODIMENTS

The following will clearly and completely describes the technical solutions in the embodiments of the present disclosure with reference to the accompanying drawings in the embodiments of the present disclosure. Apparently, the described embodiments are merely a part rather than all of the embodiments of the present disclosure. All other embodiments obtained by a person skilled in the art on the basis of the embodiments of the present disclosure without inventive efforts shall belong to the scope of protection of the present disclosure.

At present, after a thin-provisioned file is copied across hosts, the thin-provisioned file becomes a thick-provisioned file, and in this way, the file loses the advantages of thin provision. Therefore, the present disclosure provides a thin-provisioned file copying solution, which enables a thin-provisioned file to retain the advantages of thin provision after being copied across hosts, and saves physical storage space of a destination host.

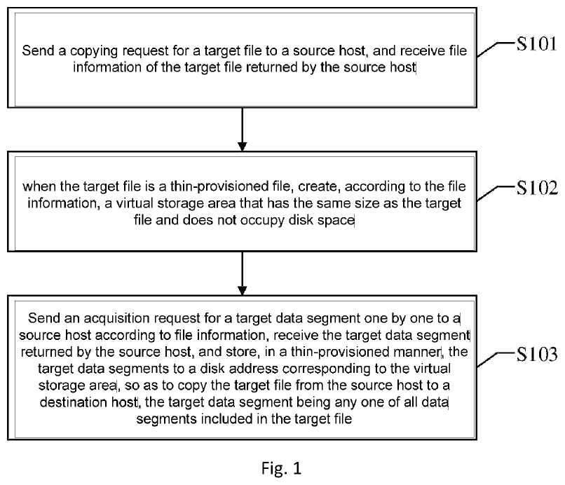

Referring to FIG. 1, an embodiment of the present disclosure discloses a thin-provisioned file copying method, which is applied to a destination host, and includes:

S101. Send a copying request for a target file to a source host, and receive file information of the target file returned by the source host.

In an embodiment, the types of file systems deployed by the source host and the destination host are different. Certainly, the types of file systems deployed by the source host and the destination host may also be the same. If the types of file systems deployed by the source host and the destination host are different, the embodiment can realize copying of a thin-provisioned file across hosts and file systems. If the types of file systems deployed by the source host and the destination host are the same, the embodiment can realize copying of a thin-provisioned file across hosts. The types of file systems are as follows: ext3/4 (Third/Fourth extended file system), XFS (a high performance 64-bit log file system developed by Silicon Graphics Inc. in 1993), btrfs (b-tree file system, a file system developed by Oracle on the basis of the copy-on-write principle), OCFs2 (original Cluster File system version 2, Oracle cluster file system version 2). The source host and the destination host communicate through socket. At present, various types of file systems support thin provision.

It should be noted that, there are multiple ways to trigger file copying: it can be triggered by a user on the source host, and the source host notifies the destination host to perform subsequent operations; it can also be triggered by the user on the destination host, and the destination host sends a copying request for a file to trigger the source host to reply, and certainly, it may also be that: the user first triggers the source host on the source host to perform the preparation work required for copying the target file, and then triggers the destination host on the destination host to send a copying request for the target file to the source host.

In an embodiment, before a destination host sends a copying request for a target file to a source host, the source host parses metadata of the target file according to the type of a file system deployed by the source host, so as to obtain a disk location where each data segment included in the target file is stored, and sends a copying notification message for the target file to the destination host, so that the destination host sends a copying request for the target file to the source host. In this way, a copying operation is triggered by a user on a source host, so that the source host learns which file is to be copied currently, and then performs corresponding preparation work (i.e. parsing metadata of a file to be copied currently according to the type of a file system deployed by the source host), and then sends a copying notification message to a destination host, so that the destination host sends a copying request for the file to be copied currently; and after receiving the copying request, the source host does not need to perform corresponding preparation work, and can directly return file information to the destination host.

In an embodiment, under a user operation, a source host only sends a copying notification message for a target file to a destination host, and temporarily does not perform corresponding preparation work; after receiving the copying notification message, the destination host sends a copying request for the target file to the source host; and after receiving the copying request, the source host parses metadata of the target file according to the type of a file system deployed by the source host, so as to obtain a disk location where each data segment included in the target file is stored, and returns file information to the destination host.

In an embodiment, before a source host returns file information, when a target file is a thin-provisioned file, the source host parses metadata of the target file according to the type of a file system deployed by the source host, so as to obtain a disk location where each data segment included in the target file is stored. In this way, a copying operation is triggered by a user on a destination host, so that the destination host learns which file is to be copied currently, and then the destination host sends a copying request for the file to be copied currently to a source host, so that the source host performs corresponding preparation work on the basis of the file, and then returns file information. The file information includes: the size of a target file, the identification information (such as, MD5 value) of the target file, the number of data segments included in the target file, and the offset address and length of each data segment.

In an embodiment, before a destination host sends a copying request for a target file to a source host, the source host parses metadata of the target file according to the type of a file system deployed by the source host, so as to obtain a disk location where each data segment included in the target file is stored, and waits for a copying request. In this way, the user first triggers the source host on the source host to perform the preparation work required for copying the target file, and then triggers the destination host on the destination host to send a copying request for the target file to the source host.

S102. when the target file is a thin-provisioned file, create, according to the file information, a virtual storage area that has the same size as the target file and does not occupy disk space.

In the present disclosure, a file stored in a thin-provisioned manner is referred to as a thin-provisioned file (such as QCOW2), and a file stored in a thick-provisioned manner is referred to as a thick-provisioned file. The thick provision means: when virtual space is created, corresponding physical storage space is directly allocated, and when there is an i/o operation, there is no need to allocate physical storage space again.

QCOW2 (QEMU Copy On Write version 2, QEMU copy-on-write file format version 2) is an image file format supported by QEMU (Quick Emulator, an open-source hypervisor capable of performing hardware virtualization), the main feature of which is to support a thin provision function of disk image files, and it can be considered as an image file format specially developed by QEMU to support the thin provision function of files.

In this embodiment, the file information can further include a flag bit indicating whether the target file is a thin-provisioned file, so that the destination host can learn whether the target file is a thin-provisioned file, and then perform corresponding steps. If the target file is not a thin-provisioned file, the destination host creates, according to the file information, a virtual storage area that has the same size as the target file and occupies disk space, so as to store the target file in a thick-provisioned manner.

The thick-provisioned manner includes: thick-provisioned delayed zeroing and thick-provisioned zeroing. The thick-provisioned delayed zeroing means: when a virtual disk is created, space is directly allocated from the physical disk, but data reserved on the physical disk is not zeroed; and when there is an i/o operation, it is necessary to perform a zeroing operation before writing data. The thick-provisioned zeroing means: when virtual space is created, corresponding physical storage space is directly allocated, and a zeroing operation is performed on data reserved on a physical disk, and when there is an i/o operation, there is no need to perform a zeroing operation, and data can be written directly.

S103. Send, according to the file information, an acquisition request for a target data segment to a source host one by one, receive the target data segment returned by the source host, and store, in a thin-provisioned manner, the target data segment in a disk address corresponding to the virtual storage area, so as to copy the target file from the source host to the destination host, the target data segment being any one of all data segments included in the target file.

It should be noted that the destination host sends an acquisition request for each data segment one by one according to the offset address and length of each data segment in the file information and according to the order of each data segment in the target file, so that the source host returns each data segment one by one. Every time the destination host receives a data segment, the destination host stores the current data segment to a disk address corresponding to the virtual storage area in a thin-provisioned manner, and the process is repeated in this way until all data segments included in the target file are stored on the disk of the destination host.

In an embodiment, after copying the target file from the source host to the destination host, the method further includes: combining all data segments of the target file stored in the destination host into a destination file, and determining whether the destination file is consistent with the target file; and if so, sending a notification message indicating that the target file is successfully copied to the source host. Determining whether the destination file is consistent with the target file includes: calculating a destination MD5 value of the destination file, acquiring a source MD5 value of the target file from the file information, and determining whether the destination MD5 value is consistent with the source MD5 value. If the destination file is inconsistent with the target file, a notification message indicating that the target file is failed to be copied is sent to the source host, and an error is reported. Then, the technician can choose, according to the error message, whether to copy the target file from the source host to the destination host again.

It should be noted that, in this embodiment, only valid data in the target file (i.e. all data segments included in the target file) is transferred to the destination host, and the amount of data in the file to be transferred may also be reduced, thereby improving the transfer speed of the file, and improving the copying efficiency.

Hence, in the process of copying the thin-provisioned file from the source host to the destination host in the embodiment of the present disclosure, the destination host creates a virtual storage area that has the same size as the thin-provisioned file and does not occupy disk space, so as to prepare for storage of subsequent data. When the data included in the thin-provisioned file really needs to be written, a corresponding disk address is allocated for the data to be stored on the disk, so that after the thin-provisioned file is copied from the source host to the destination host, the thin-provisioned file is still a thin-provisioned file in the destination host. Therefore, after the thin-provisioned file is copied across the hosts, the advantages of thin provision is retained, and physical storage space of the destination host is also saved.

Provided in an embodiment of the present disclosure is another thin-provisioned file copying method, and the method is triggered in the following manner: a user first triggering a source host on the source host to perform preparation work required for copying a target file, and then triggering a destination host on the destination host to send a copying request for the target file to the source host. Specifically, a user triggers, on the basis a human-computer interaction interface of a source host, the running of a file transfer service in the source host, and designates a target file to be copied, so as to use the file transfer service to parse metadata of the target file, and obtain a disk location where each data segment included in the target file is stored (i.e. the distribution of data on the disk); then, the user designates, on the basis of a human-computer interaction interface of a destination host, the target file to be copied, and triggers the destination host to send a copying request for the target file to the source host, so as to perform the subsequent process. The file transfer service may be expanded to be compatible with various types of file systems.

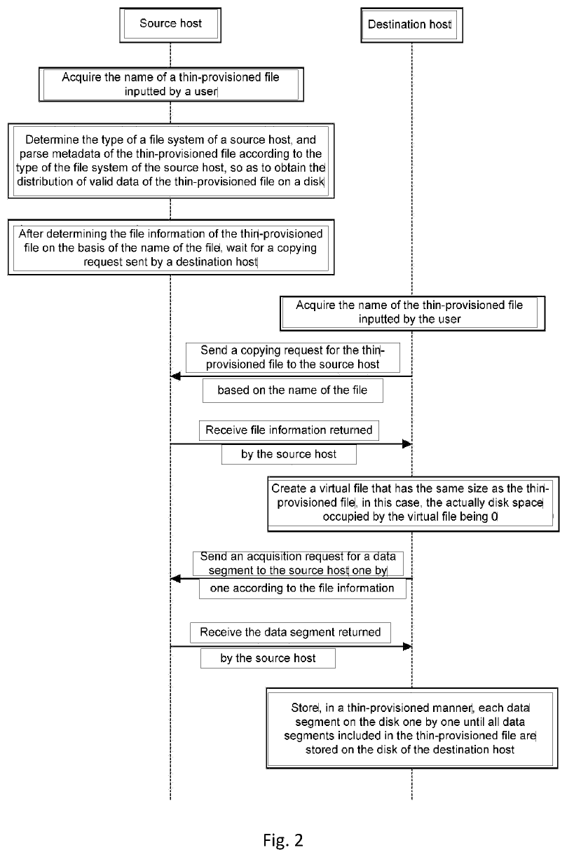

As shown in FIG. 2, a source host uses a file transfer service (i.e. server service) running thereon to specifically:

acquire the name of a thin-provisioned file inputted by a user; determine the type of a file system of a source host, and parse metadata of the thin-provisioned file according to the type of the file system of the source host, so as to obtain the distribution of valid data of the thin-provisioned file on a disk; and

after determining the file information of the thin-provisioned file on the basis of the name of the file, wait for a copying request sent by the destination host.

The destination host uses a client process running thereon to specifically: acquire the name of the thin-provisioned file inputted by the user; send, on the basis of the name of the file, a copying request for the thin-provisioned file to the source host;

receive file information returned by the source host; create a virtual file that has the same size as the thin-provisioned file, in this case, the actually disk space occupied by the virtual file being 0; send, according to the file information, an acquisition request for a data segment to the source host one by one; receive the data segment returned by the source host; and query a physical address corresponding to the virtual file, and store, in a thin-provisioned manner, each data segment on the disk one by one until all data segments included in the thin-provisioned file are stored on the disk of the destination host.

The acquisition request for a data segment sent by the destination host includes the offset address and length of the data segment; and the data returned by the source host includes the offset address and length of the data segment and the data segment itself.

After the data segments included in the thin-provisioned file are all stored on the disk of the destination host, the destination host calculates an MD5 value of the thin-provisioned file that has been stored on the disk of the destination host, and if the MD5 value is the same as the MD5 value in the file information, it indicates that the copying is successful. In this case, the socket connection between the destination host and the source host may be disconnected, and the file transfer service and the client process are closed. Otherwise, an error is reported.

In this embodiment, a server service is implemented at a source end of a file; and the server can parse metadata of a thin-provisioned file according to the type of a file system at the source end to obtain actual data distribution of the thin-provisioned file, and then start to wait for a client request. A client process is started at a destination end, the client sends a copying request to a source end, and after obtaining a response, creates a virtual file that has the same size as a thin-provisioned file but occupies 0 disk space; and then the destination end requests a data segment from the source end, and after receiving a response, performs a disk storage operation on the data segment in a thin-provisioned manner. Finally, after obtaining all the data segments of the thin-provisioned file, the destination end determines whether the disk-stored file is correct according to the MD5 value of the file. Hence, the solution does not depend on the types of file systems of a source end and a destination end, and supports copying of a thin-provisioned file across file systems and hosts.

The present embodiment uses a C/S structure (a client-server mode), has good extensibility, and can implement extension only by writing corresponding metadata parsing logic for different types of file systems; and as a data transmission format does not depend on a specific file system, the present embodiment can also support copying for thin provision across file systems, thereby further improving the application scope of thin provision features, and also solving the problem of migration and backup of thin-provisioned image files across hosts in virtualization scenarios.

The following introduces a thin-provisioned file copying apparatus according to an embodiment of the present disclosure, and the thin-provisioned file copying apparatus described in the following and the thin-provisioned file copying method described in the foregoing may make reference to each other.

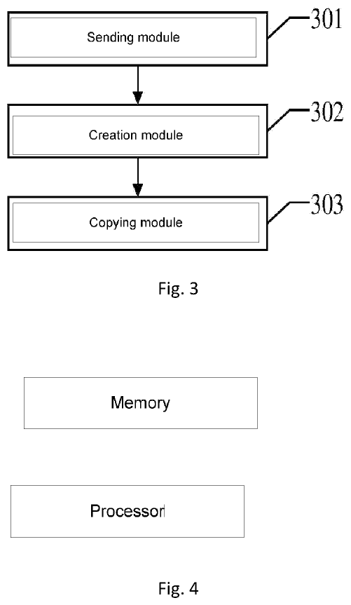

Referring to FIG. 3, an embodiment of the present disclosure discloses a thin-provisioned file copying apparatus, which is applied to a destination host and includes:

a sending module 301, configured to send a copying request for a target file to a source host, and receive file information of the target file returned by the source host;

a creation module 302, configured to create, according to the file information, a virtual storage area that has the same size as the target file and does not occupy disk space if the target file is a thin-provisioned file;

a copying module 303, configured to send, according to the file information, an acquisition request for a target data segment to the source host one by one, receive the target data segment returned by the source host, and store, in a thin-provisioned manner, the target data segment to a disk address corresponding to the virtual storage area, so as to copy the target file from the source host to the destination host, the target data segment being any one of all data segments included in the target file.

In an embodiment, before a destination host sends a copying request for a target file to a source host, the source host parses metadata of the target file according to the type of a file system deployed by the source host, so as to obtain a disk location where each data segment included in the target file is stored, and sends a copying notification message for the target file to the destination host.

In an embodiment, before a source host returns file information, if a target file is a thin-provisioned file, the source host parses metadata of the target file according to the type of a file system deployed by the source host, so as to obtain a disk location where each data segment included in the target file is stored.

In an embodiment, before a destination host sends a copying request for a target file to a source host, the source host parses metadata of the target file according to the type of a file system deployed by the source host, so as to obtain a disk location where each data segment included in the target file is stored, and waits for a copying request.

In an embodiment, the thin-provisioned file copying apparatus further includes:

a determination module, configured to combine all data segments of the target file stored in the destination host into a destination file, and determining whether the destination file is consistent with the target file; and

a notification module, configured to send a notification message indicating that the copying of the target file is successful to the source host if the destination file is consistent with the target file.

In an embodiment, the determination module is specifically configured to:

calculate a destination MD5 value of the destination file, acquire a source MD5 value of the target file from the file information, and determining whether the destination MD5 value is consistent with the source MD5 value.

In an embodiment, the thin-provisioned file copying apparatus further includes:

the notification module, specifically configured to send a notification message indicating that the copying of the target file fails to the source host if the destination file is inconsistent with the target file.

In an embodiment, the types of file systems deployed by the source host and the destination host are different.

For a more specific working process of each module and unit in this embodiment, reference may be made to corresponding content disclosed in the foregoing embodiments, and details are not described herein again.

Hence, this embodiment provides a thin-provisioned file copying apparatus, and in the process of copying a thin-provisioned file from a source host to a destination host, the destination host creates a virtual storage area that has the same size as the thin-provisioned file and does not occupy disk space so as to prepare for storage of subsequent data. When the data included in the thin-provisioned file really needs to be written, a corresponding disk address is allocated for the data to be stored on the disk, so that after the thin-provisioned file is copied from the source host to the destination host, the thin-provisioned file is still a thin-provisioned file in the destination host. Therefore, after the thin-provisioned file is copied across the hosts, the advantages of thin provision is retained, and physical storage space of the destination host is also saved.

The following introduces a thin-provisioned file copying device according to an embodiment of the present disclosure, and the thin-provisioned file copying device described in the following and the thin-provisioned file copying method described in the foregoing may make reference to each other.

Referring to FIG. 4, an embodiment of the present disclosure discloses a thin-provisioned file copying device, comprising:

a memory 401, configured to store a computer program; and

a processor 402, configured to execute the computer program to implement the method disclosed in any one of the foregoing embodiments.

The following introduces a readable storage medium according to an embodiment of the present disclosure, and the readable storage medium described in the following and the thin-provisioned file copying method, apparatus and device described in the foregoing may make reference to each other.

A readable storage medium is configured to store a computer program, and the computer program, when being executed by a processor, implements the thin-provisioned file copying method disclosed in the foregoing embodiments. For specific steps of the method, reference may be made to corresponding content disclosed in the foregoing embodiments, and details are not described herein again.

The terms “first”, “second”, “third”, “fourth”, and the like (if any) in the present disclosure are used to distinguish similar objects, and are not necessarily used to describe a specific sequence or order. It should be understood that the data so used may be interchanged where appropriate so that the embodiments described herein may be practiced in an order other than that illustrated or described herein. In addition, the terms ‘include’ and ‘have’, and any variations thereof, are intended to cover a non-exclusive inclusion, for example, a process, method or apparatus that includes a series of steps or units is not necessarily limited to those steps or units that are expressly listed, but may include other steps or units that are not expressly listed or inherent to such process, method or apparatus.

It should be noted that, the description relating to “first” and “second” in the present disclosure is only used for the purpose of description, and cannot be understood as indicating or implying the relative importance thereof or implicitly indicating the number of indicated technical features. Thus, the features defined by “first” and “second” may explicitly or implicitly include at least one of the features. In addition, the technical solutions of the embodiments can be combined with each other, but they must be based on the implementation of a person of ordinary skill in the art. When the combination of the technical solutions is contradictory or cannot be implemented, it should be considered that the combination of the technical solutions does not exist, and also does not belong to the scope of protection of the present disclosure.

The embodiments in this description are described in a progressive manner. Each embodiment focuses on a difference from other embodiments. For the same or similar parts among the embodiments, reference may be made to each other.

The steps of a method or algorithm described in connection with the embodiments disclosed herein may be embodied directly in hardware, in a software module executed by a processor, or in a combination of the two. The software module may be disposed in a random access memory (RAM), a memory, a read-only memory (ROM), an electrically programmable ROM, an electrically erasable programmable ROM, a register, a hard disk, a removable magnetic disk, a CD-ROM, or any other form of readable storage medium known in the art.

The principle and embodiments of the present disclosure are illustrated in the present disclosure by using specific examples. The description of the embodiments above is only used to help understand the method of the present disclosure and the core idea thereof. Meanwhile, based on the idea of the present disclosure, a person of ordinary skill in the art may make changes to specific implementations and application scopes according to the idea of the present disclosure. In conclusion, the content of the present disclosure shall not be construed as a limitation to the present disclosure.

1. A thin-provisioned file copying method, applied to a destination host, and comprising:
sending a copying request for a target file to a source host, and receiving file information of the target file returned by the source host;
when the target file is a thin-provisioned file, creating, according to the file information, a virtual storage area that has the same size as the target file and does not occupy disk space;
sending, according to the file information, an acquisition request for a target data segment to the source host one by one, receiving the target data segment returned by the source host, and storing, in a thin-provisioned manner, the target data segment to a disk address corresponding to the virtual storage area, so as to copy the target file from the source host to the destination host, the target data segment being any one of all data segments included in the target file.

2. The thin-provisioned file copying method according to claim 1, wherein before sending a copying request for a target file to a source host, the method further comprises:
parsing, by the source host, metadata of the target file according to the type of a file system deployed by the source host, so as to obtain a disk location where each data segment included in the target file is stored, and sending a copying notification message for the target file to the destination host.

3. The thin-provisioned file copying method according to claim 1, wherein before the source host returns the file information, the method further comprises:
when the target file is a thin-provisioned file, parsing, by the source host, metadata of the target file according to the type of the file system deployed by the source host, so as to obtain the disk location where each data segment included in the target file is stored.

4. The thin-provisioned file copying method according to claim 1, wherein before sending a copying request for a target file to a source host, the method further comprises:
parsing, by the source host, metadata of the target file according to the type of the file system deployed by the source host, so as to obtain the disk location where each data segment included in the target file is stored, and waiting for the copying request.

5. The thin-provisioned file copying method for according to claim 2, wherein after copying the target file from the source host to the destination host, the method further comprises:
combining all data segments of the target file stored in the destination host into a destination file, and determining whether the destination file is consistent with the target file;
when the destination file is consistent with the target file, sending to the source host a notification message indicating that the target file is successfully copied;
when the destination file is inconsistent with the target file, sending to the source host a notification message indicating that the target file is failed to be copied.

6. The thin-provisioned file copying method according to claim 5, wherein determining whether the destination file is consistent with the target file comprises:
calculating a destination Message Digest 5 (MD5) value of the destination file, acquiring a source MD5 value of the target file from the file information, and determining whether the destination MD5 value is consistent with the source MD5 value.

7. The thin-provisioned file copying method according to claim 5, wherein the types of file systems deployed by the source host and the destination host are different.

8. (canceled)

9. A thin-provisioned file copying device, wherein the device comprises:
a memory, configured to store a computer program; and
a processor, configured to execute the computer program to:
send a copying request for a target file to a source host, and receiving file information of the target file returned by the source host;
when the target file is a thin-provisioned file, create, according to the file information, a virtual storage area that has the same size as the target file and does not occupy disk space;
send, according to the file information, an acquisition request for a target data segment to the source host one by one, receiving the target data segment returned by the source host, and storing, in a thin-provisioned manner, the target data segment to a disk address corresponding to the virtual storage area, so as to copy the target file from the source host to the destination host, the target data segment being any one of all data segments included in the target file.

10. A readable storage medium, wherein the storage medium is configured to store a computer program, wherein the computer program, when being executed by a processor, cause the processor to:
send a copying request for a target file to a source host, and receiving file information of the target file returned by the source host;
when the target file is a thin-provisioned file, create, according to the file information, a virtual storage area that has the same size as the target file and does not occupy disk space;
send, according to the file information, an acquisition request for a target data segment to the source host one by one, receiving the target data segment returned by the source host, and storing, in a thin-provisioned manner, the target data segment to a disk address corresponding to the virtual storage area, so as to copy the target file from the source host to the destination host, the target data segment being any one of all data segments included in the target file.

11. The thin-provisioned file copying device according to claim 9, the processor is further configured to execute the computer program to:
parse metadata of the target file according to the type of a file system deployed by the source host, so as to obtain a disk location where each data segment included in the target file is stored, and send a copying notification message for the target file to the destination host.

12. The thin-provisioned file copying device according to claim 9, the processor is further configured to execute the computer program to:
when the target file is a thin-provisioned file, parse the metadata of the target file according to the type of file system deployed by the source host, so as to obtain the disk location where each data segment included in the target file is stored.

13. The thin-provisioned file copying device according to claim 9, the processor is further configured to execute the computer program to:
parse the metadata of the target file according to the type of file system deployed by the source host, so as to obtain the disk location where each data segment included in the target file is stored, and wait for the copying request.

14. The thin-provisioned file copying device according to claim 11, the processor is further configured to execute the computer program to:
combine all data segments of the target file stored in the destination host into a destination file, and determining whether the destination file is consistent with the target file;
when the destination file is consistent with the target file, send to the source host a notification message including that the target file is successfully copied;
when the destination file is inconsistent with the target file, send to the source host a notification message indicating that the target file is failed to be copied.

15. The thin-provisioned file copying device according to claim 14, the processor is further configured to execute the computer program to:
calculating a destination Message Digest 5 (MD5) value of the destination file, acquiring a source MD5 value of the target file from the file information, and determining whether the destination MD5 value is consistent with the source MD5 value.

16. The thin-provisioned file copying device according to claim 14, the processor is further configured to execute the computer program to:
wherein the types of file systems deployed by the source host and the destination host are different.

17. The thin-provisioned file copying method according to claim 1, wherein the type of file systems deployed by the source host and the destination host are the same.

18. The thin-provisioned file copying method according to claim 1, wherein the type of the file systems comprise one of: Third/Fourth extended file system (ext3/4), X File System (XFS), b-tree file system (btrfs), Oracle Cluster File system version 2 (OCFs2).

19. The thin-provisioned file copying method according to claim 1, wherein the source host and the destination host communicate through socket.

20. The thin-provisioned file copying method according to claim 1, wherein the file information further comprises a flag bit indicating whether the target file is a thin-provisioned file, when the target file is not a thin-provisioned file, the destination host creates, according to the file information, a virtual storage area that has the same size as the target file and occupies disk space, so as to store the target file in a thick-provisioned manner.

21. The thin-provisioned file copying method according to claim 20, wherein the thick-provisioned manner comprises: a thick-provisioned delayed zeroing and thick-provisioned zeroing.
